(19) United States
(12) Patent Application Publication
(10) Pub. No.: US 2026/0111055 A1
(43) Pub. Date: Apr. 23, 2026

(54) GLASS SUBSTRATE, WINDOW, AND ELECTRONIC DEVICE INCLUDING THE SAME

(71) Applicant: Samsung Display Co., Ltd., Yongin-si (KR)

(72) Inventors: JEONG SEOK LEE, Yongin-si (KR); SEUNGPYO HONG, Yongin-si (KR)

(21) Appl. No.: 19/293,541

(22) Filed: Aug. 7, 2025

(30) Foreign Application Priority Data
Oct. 17, 2024 (KR) 10-2024-0141865

(51) Int. Cl. G06F 1/16

(52) U.S. Cl. CPC G06F 1/1629; G06F 1/1652

(57) ABSTRACT

A glass substrate, a window including the glass substrate, and an electronic device including the window are disclosed. The glass substrate may include a first area where a groove is formed or arranged and a second area substantially continuous with the first area. A difference (ΔCT) between internal tensile stress at a point of a first portion having a minimum thickness and internal tensile stress at a point of a second portion having a maximum thickness may be at most 100 MPa.

### CROSS-REFERENCE TO RELATED APPLICATION

The present application claims priority to and the benefit of Korean Patent Application No. 10-2024-0141865, filed on Oct. 17, 2024, in the Korean Intellectual Property Office, the entire disclosure of which is incorporated herein by reference.

### BACKGROUND

### 1. Field

One or more embodiments of the present disclosure relate to a glass substrate, a window including the glass substrate, and an electronic device including the window. For example, the embodiments relate to a glass substrate including portions having different thicknesses, a window including the glass substrate, and an electronic device including the window.

### 2. Description of the Related Art

Electronic devices may provide information to users by displaying an image. In recent years, various types (kinds) of electronic devices have been developed. For example, foldable electronic devices have been developed.

Electronic devices include a display device and a window. The window includes a glass substrate. A window is being developed to improve or enhance the impact resistance and strength of its outer surface and to reduce stress generated during folding.

### SUMMARY

One or more embodiments of the present disclosure are directed toward a chemically strengthened glass substrate with reduced deformation.

One or more embodiments of the present disclosure are directed toward a window including the glass substrate.

One or more embodiments of the present disclosure are directed toward an electronic device including the window.

Additional aspects of embodiments will be set forth in part in the description which follows and, in part, will be apparent from the description or may be learned by practice of the presented embodiments of the disclosure.

According to one or more embodiments, a glass substrate includes a first portion having a groove defined thereon and a second portion that extends from the first portion and is thicker than the first portion. Each of the first portion and the second portion includes a first compressive stress area having a first depth from a first surface, a second compressive stress area having a second depth from a second surface that is opposite to (e.g., faces) the first surface, and a tensile stress area between the first compressive stress area and the second compressive stress area. A difference (ΔCT) between internal tensile stress at a point of the first portion having a minimum thickness and internal tensile stress at a point of the second portion having a maximum thickness is at most (e.g., equal to or less than) 100 MPa.

The first depth of the first compressive stress area of the first portion may be substantially the same as the second depth of the first compressive stress area of the second portion.

The difference (ΔCT) between the internal tensile stress at the point of the first portion having the minimum thickness and the internal tensile stress at the point of the second portion having the maximum thickness may satisfy Equation 1:

$$Δ CT = ( \frac{{CS}_{1} \times 1 \times Ratio}{1 - 2 \times 1 \times Ratio} ) - ( \frac{{CS}_{2} \times 1 \times Ratio}{\frac{{t}_{2}}{{t}_{1}} - 2 \times 1 \times Ratio} ) \qquad Equation 1$$

wherein, CS₁ may be defined as a surface compressive stress of the first portion, CS₂ may be defined as a surface compressive stress of the second portion, t₁ may be defined as a thickness of the first portion, t₂ may be defined as a thickness of the second portion, and Ratio may be defined as a value obtained by dividing a depth of layer (DOL) of the first portion by t₁.

The surface compressive stress CS₁ of the first portion may be substantially the same as the surface compressive stress CS₂ of the second portion.

The Ratio may be in a range from 0.15 to 0.25.

The surface compressive stress CS₁ of the first portion and the surface compressive stress CS₂ of the second portion may each be in a range from 500 MPa to 700 MPa.

t₁ may be in a range from 20 μm to 50 μm, and t₂ may be in a range from 30 μm to 300 μm.

According to one or more embodiments, a window includes a glass substrate and a resin layer arranged on one surface of the glass substrate. The glass substrate includes a first portion on which a groove filled with the resin layer is defined and a second portion that extends from the first portion and is thicker than the first portion. Each of the first portion and the second portion includes a first compressive stress area having a first depth from a first surface, a second compressive stress area having a second depth from a second surface that is opposite to (e.g., faces) the first surface, and a tensile stress area between the first compressive stress area and the second compressive stress area. A difference (ΔCT) between internal tensile stress at a point of the first portion having a minimum thickness and internal tensile stress at a point of the second portion having a maximum thickness is at most (e.g., equal to or less than) 100 MPa.

The resin layer may overlap the first portion and the second portion, and a thickness of the window corresponding to the first portion may be substantially the same as a thickness of the window corresponding to the second portion.

The depth of the first compressive stress area of the first portion may be substantially the same as the depth of the first compressive stress area of the second portion.

The difference (ΔCT) between the internal tensile stress at the point of the first portion having the minimum thickness and the internal tensile stress at the point of the second portion having the maximum thickness may satisfy Equation 1:

$$Δ CT = ( \frac{{CS}_{1} \times 1 \times Ratio}{1 - 2 \times 1 \times Ratio} ) - ( \frac{{CS}_{2} \times 1 \times Ratio}{\frac{{t}_{2}}{{t}_{1}} - 2 \times 1 \times Ratio} ) \qquad Equation 1$$

wherein, CS₁ may be defined as a surface compressive stress of the first portion, CS₂ may be defined as a surface compressive stress of the second portion, t₁ may be defined as a thickness of the first portion, t₂ may be defined as a thickness of the second portion, and Ratio may be defined as a value obtained by dividing a depth of layer (DOL) of the first portion by t₁.

The surface compressive stress CS₁ of the first portion may be substantially the same as the surface compressive stress CS₂ of the second portion.

The Ratio may be in a range from 0.15 to 0.25.

The surface compressive stress CS₁ of the first portion and the surface compressive stress CS₂ of the second portion may each be in a range from 500 MPa to 700 MPa.

t₁ may be in a range from 20 μm to 50 μm, and t₂ may be in a range from 30 μm to 300 μm.

According to one or more embodiments, an electronic device includes a display panel and a window. The window is arranged on the display panel and includes a glass substrate and a resin layer arranged on one surface of the glass substrate. The glass substrate includes a first portion on which a groove filled with the resin layer is defined and a second portion that extends from the first portion and is thicker than the first portion. Each of the first portion and the second portion includes a first compressive stress area having a first depth from a first surface, a second compressive stress area having a second depth from a second surface that is opposite to (e.g., faces) the first surface, and a tensile stress area between the first compressive stress area and the second compressive stress area.

A difference (ΔCT) between internal tensile stress at a point of the first portion having a minimum thickness and internal tensile stress at a point of the second portion having a maximum thickness is at most (e.g., equal to or less than) 100 MPa.

The resin layer may overlap the first portion and the second portion. A thickness of the window corresponding to the first portion may be substantially the same as a thickness of the window corresponding to the second portion.

The electronic device may be foldable with respect to a folding axis, and the folding axis may be defined to overlap the groove and may extend in substantially the same direction as the groove.

The difference (ΔCT) between the internal tensile stress at the point of the first portion having the minimum thickness and the internal tensile stress at the point of the second portion having the maximum thickness may satisfy Equation 1:

$$Δ CT = ( \frac{{CS}_{1} \times 1 \times Ratio}{1 - 2 \times 1 \times Ratio} ) - ( \frac{{CS}_{2} \times 1 \times Ratio}{\frac{{t}_{2}}{{t}_{1}} - 2 \times 1 \times Ratio} ) \qquad Equation 1$$

wherein, CS₁ may be defined as a surface compressive stress of the first portion, CS₂ may be defined as a surface compressive stress of the second portion, t₁ may be defined as a thickness of the first portion, t₂ may be defined as a thickness of the second portion, and Ratio may be defined as a value obtained by dividing a depth of layer (DOL) of the first portion by t₁.

The surface compressive stress CS₁ of the first portion may be substantially the same as the surface compressive stress CS₂ of the second portion, and the Ratio may be in a range from 0.15 to 0.25.

One or more embodiments of the present disclosure are directed toward a chemically strengthened glass substrate with reduced deformation, a window including the glass substrate, and an electronic device including the window. The glass substrate features a first portion with a groove and a thicker second portion, both having compressive stress areas and a tensile stress area between them. The difference in internal tensile stress between the thinnest and thickest points is at most 100 MPa, satisfying Equation 1:

$$Δ CT = ( \frac{{CS}_{1} \times 1 \times Ratio}{1 - 2 \times 1 \times Ratio} ) - ( \frac{{CS}_{2} \times 1 \times Ratio}{\frac{{t}_{2}}{{t}_{1}} - 2 \times 1 \times Ratio} ) \qquad Equation 1$$

The window includes a resin layer overlapping both portions, maintaining consistent thickness and stress characteristics. The electronic device, that is, e.g., foldable, incorporates this window on its display panel, ensuring durability and reduced stress during folding.

### BRIEF DESCRIPTION OF THE DRAWINGS

The above and other aspects and features of certain embodiments of the present disclosure will become more apparent by describing in more detail one or more embodiments thereof with reference to the accompanying drawings.

FIG. 1A is a block diagram of an electronic device according to one or more embodiments of the present disclosure.

FIGS. 1B-1D are perspective views of electronic devices according to embodiments of the present disclosure.

FIGS. 2A-2C are perspective views of the electronic device according to one or more embodiments of the present disclosure.

FIG. 3 is an exploded perspective view of the electronic device according to one or more embodiments of the present disclosure.

FIG. 4A is a sectional view of a window according to one or more embodiments of the present disclosure.

FIG. 4B is an enlarged sectional view of a portion of FIG. 4A.

FIG. 4C is a sectional view of the window according to one or more embodiments of the present disclosure.

FIG. 5A is a sectional view illustrating a method of manufacturing the window according to one or more embodiments of the present disclosure.

FIG. 5B illustrates a chemical strengthening method of a glass substrate according to one or more embodiments of the present disclosure.

FIG. 6 is a graph depicting a change in the stress of the glass substrate according to one or more embodiments of the present disclosure.

FIG. 7 is a graph depicting a difference in internal stress (e.g., internal tensile stress (ΔCT)) between a first point and a second point of the glass substrate versus the ratio of the thickness of the second point to the thickness of the first point according to one or more embodiments of the present disclosure.

FIGS. 8A-8C are views illustrating glass substrates according to embodiments of the present disclosure.

### DETAILED DESCRIPTION

The subject matter of the present disclosure will be described more fully hereinafter with reference to the accompanying drawings, in which embodiments of the present disclosure are shown. As those skilled in the art would realize, the described embodiments may be modified in one or more suitable different ways, all without departing from the spirit or scope of the present disclosure. The drawings and description are to be regarded as illustrative in nature and not restrictive. Like reference numerals designate like elements throughout the accompanying drawings and the written description, and duplicative descriptions thereof may not be provided in the specification.

The utilization of “may” if (e.g., when) describing embodiments of the present disclosure refers to “one or more embodiments of the present disclosure.”

In the context of the present application and unless otherwise defined, the terms “use,” “using,” and “used” may be considered synonymous with the terms “utilize,” “utilizing,” and “utilized,” respectively.

Throughout the present disclosure, the expression “at least one of a, b, or c” or “at least one selected from among a, b, and c” indicates only a, only b, only c, both (e.g., simultaneously) a and b, both (e.g., simultaneously) a and c, both (e.g., simultaneously) b and c, all of a, b, and c, or variations thereof.

In the present disclosure, if (e.g., when) a component (e.g., an area, a layer, a part, and/or the like) is referred to as being “on”, “connected to”, or “coupled to” another component, this refers to that the component may be directly on, directly connected to, or directly coupled to the other component or a third component may be present therebetween. In contrast, if (e.g., when) a component is referred to as being “directly on”, “directly connected to”, or “directly coupled to” another component, there may be no intervening components present therebetween.

In the drawings, the thicknesses, proportions, and dimensions of components may be exaggerated for effective description.

As used herein, the term “and/or” includes all of one or more combinations defined by related components.

The terms, such as “first”, “second”, and/or the like, may be used to describe one or more suitable components, but the components should not be limited by the terms. The terms may be used only to distinguish one component from other components. For example, without departing the scope of the present disclosure, a first component may be referred to as a second component, and similarly, the second component may also be referred to as the first component.

The terms of a singular form may include plural forms unless otherwise specified.

The terms, such as “below”, “under”, “above”, and “over”, are used to describe a relationship between components illustrated in the drawings. The terms are relative concepts and are described based on directions illustrated in the drawing.

It should be understood that the terms, such as “include” and “have”, if (e.g., when) used herein, specify the presence of stated features, numbers, steps, operations, components, parts, and/or one or more (e.g., any suitable) combinations thereof, but do not preclude the presence or addition of one or more other features, numbers, steps, operations, components, parts, and/or one or more (e.g., any suitable) combinations thereof. For example, it should be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Also, the terms “comprise(s)/comprising,” “include(s)/including,” “have/has/having,” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

Unless otherwise defined, all terms used herein, including technical or scientific terms, have substantially the same meanings as those generally understood by those skilled in the art to which the present disclosure pertains. Such terms as those defined in a generally used dictionary are to be interpreted as having meanings equal to the contextual meanings in the relevant field of art and are not to be interpreted as having ideal or excessively (or substantially) formal meanings unless clearly defined as having such in the present application.

Hereinafter, one or more embodiments of the present disclosure will be described in more detail with reference to the accompanying drawings.

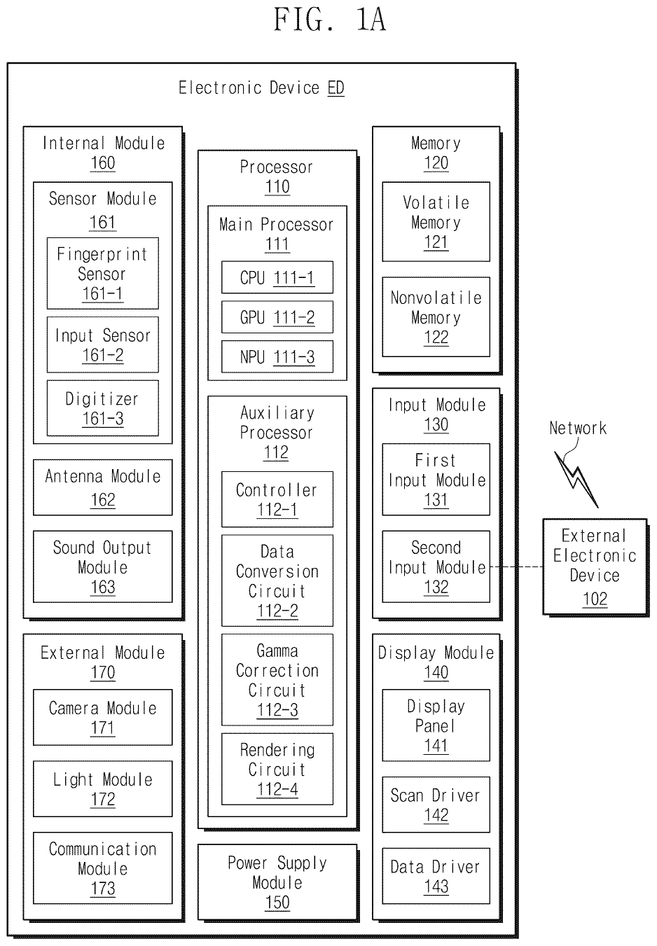

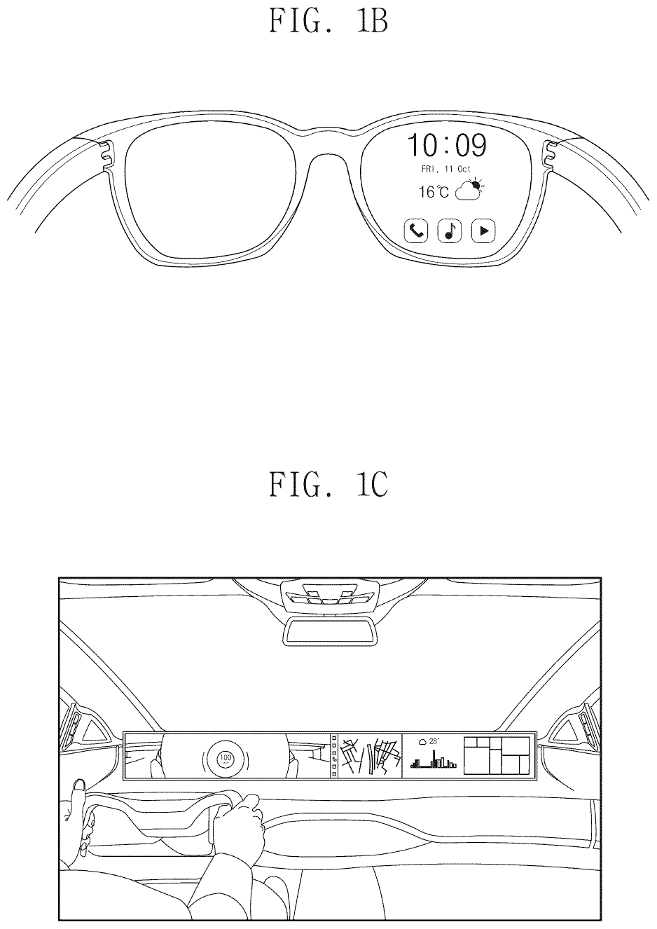

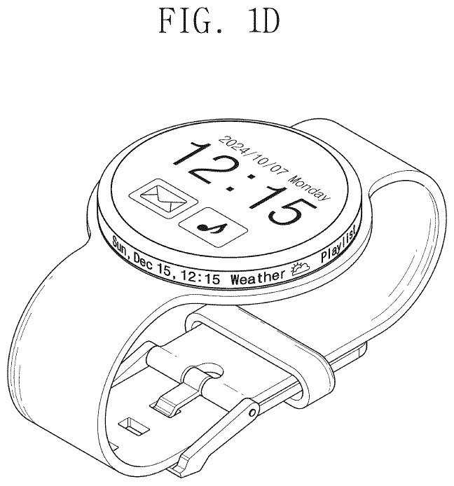

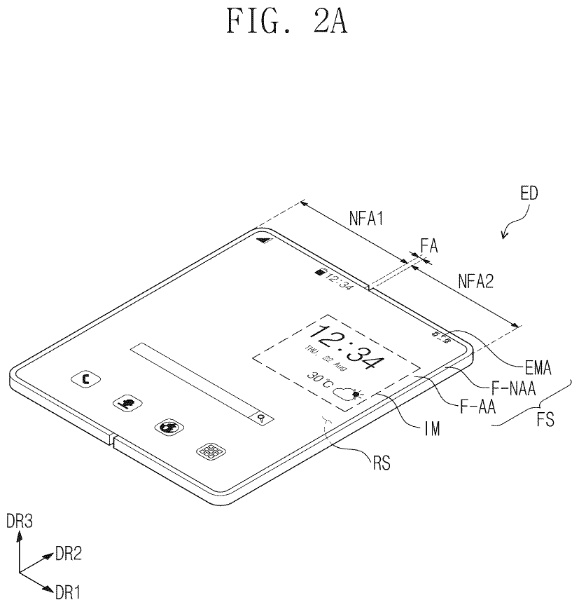

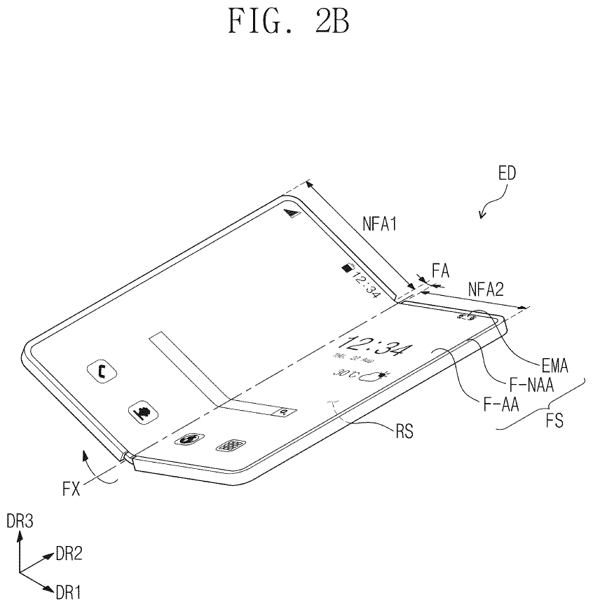

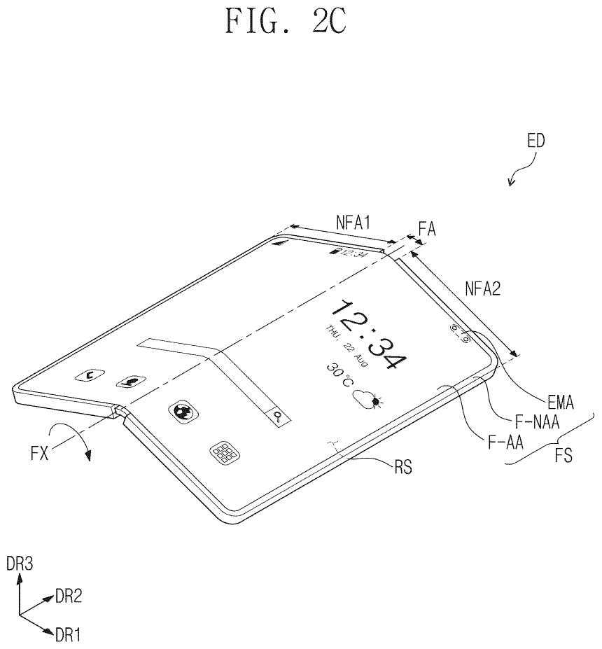

FIG. 1A is a block diagram of an electronic device ED according to one or more embodiments of the present disclosure. FIGS. 1B to 1D are perspective views of electronic devices according to embodiments of the present disclosure. FIGS. 2A to 2C are perspective views of the electronic device ED according to one or more embodiments of the present disclosure.

The electronic device ED according to one or more embodiments of the present disclosure may include a display device. The electronic device ED according to one or more embodiments of the present disclosure may be a mobile phone as illustrated in FIGS. 2A to 2C, but embodiments of the present disclosure are not limited thereto.

As illustrated in FIG. 1A, the electronic device ED may be to output one or more suitable information through a display module 140 in an operating system. If (e.g., when) a processor 110 executes an application stored in a memory 120, the display module 140 may provide a user with application information through a display panel 141.

The processor 110 may be to obtain an external input through an input module 130 and/or a sensor module 161 and execute an application corresponding to the external input. For example, if (e.g., when) the user selects a camera icon displayed on the display panel 141, the processor 110 may obtain the user input through an input sensor 161-2 and activate a camera module 171. The processor 110 may be to transfer image data corresponding to a photographed image obtained through the camera module 171 to the display module 140. The display module 140 may be to display an image corresponding to the photographed image through the display panel 141.

In another example, if (e.g., when) authentication for personal information is performed in the display module 140, a fingerprint sensor 161-1 may obtain the input fingerprint information as input data. The processor 110 may be to compare the input data obtained through the fingerprint sensor 161-1 and authentication data stored in the memory 120 and execute an application depending on a comparison result. The display module 140 may be to display information executed depending on logic of the application, through the display panel 141.

In another example, if (e.g., when) the user selects a music streaming icon displayed on the display module 140, the processor 110 may obtain the user input through the input sensor 161-2 and activate a music streaming application stored in the memory 120. If (e.g., when) a music play command is input to the music streaming application, the processor 110 may activate a sound output module 163 and provide the user with sound information corresponding to the music play command.

The operation of the electronic device ED was described in one or more embodiments. Hereinafter, a configuration or arrangement of the electronic device ED will be described in more detail. One or more of the components of the electronic device ED to be described in more detail herein may be integrally implemented with one component, and the one component may be divided into two or more components.

Referring to FIG. 1A, the electronic device ED may be to communicate with an external electronic device 102 over a network (e.g., a short-range wireless communication network or a long-range wireless communication network). According to one or more embodiments, the electronic device ED may include the processor 110, the memory 120, the input module 130, the display module 140, a power supply module 150, an internal module 160, and an external module 170. According to one or more embodiments, the electronic device ED may not include at least one selected from among the components as described in one or more embodiments or may further include one or more other components. According to one or more embodiments, one or more of the components as described in one or more embodiments (e.g., the sensor module 161, an antenna module 162, or the sound output module 163) may be integrated into any other component (e.g., the display module 140).

The processor 110 may be to execute software to control at least one other component (e.g., a hardware component and/or a software component) of the electronic device ED connected with the processor 110 and may be to perform one or more suitable data processing or operations. According to one or more embodiments, as at least a part of the data processing or operations, the processor 110 may be to store a command or data received from any other component (e.g., the input module 130, the sensor module 161, or a communication module 173) in a volatile memory 121, may be to process the command or data stored in the volatile memory 121, and may be to store the processed data in a nonvolatile memory 122.

The processor 110 may include a main processor 111 and an auxiliary processor 112. The main processor 111 may include one or more of a central processing unit (CPU) 111-1 or an application processor (AP). The main processor 111 may further include one or more of a graphic processing unit (GPU) 111-2, a communication processor (CP), and an image signal processor (ISP). The main processor 111 may further include a neural processing unit (NPU) 111-3. The neural processing unit 111-3 may be a processor specialized to process an artificial intelligence model, and the artificial intelligence model may be created through machine learning. The artificial intelligence model may include a plurality of artificial neural network layers. The artificial neural network may include one selected from among a deep neural network (DNN), a convolutional neural network (CNN), a recurrent neural network (RNN), a restricted boltzmann machine (RBM), a deep belief network (DBN), a bidirectional recurrent deep neural network (BRDNN), a deep Q-network, and/or a (e.g., any suitable) combination of two or more thereof, but embodiments of the present disclosure are not limited thereto. Additionally or alternatively, the artificial intelligence model may include a software structure in addition to a hardware structure. At least two of the processing units and processors as described in one or more embodiments may be integrally implemented with one component (e.g., a single chip), or each of the processing units and processors as described in one or more embodiments may be implemented with an independent component (e.g., a plurality of chips).

The auxiliary processor 112 may include a controller 112-1. The controller 112-1 may include an interface conversion circuit and a timing control circuit. The controller 112-1 may be to receive an image signal from the main processor 111 and output image data obtained by converting a data format of the image signal so as to be suitable for the specification of an interface with the display module 140. The controller 112-1 may be to output one or more suitable types or kinds of control signals desired or necessary to drive the display module 140.

The auxiliary processor 112 may further include a data conversion circuit 112-2, a gamma correction circuit 112-3, a rendering circuit 112-4, and/or the like. The data conversion circuit 112-2 may be to receive image data from the controller 112-1 and may be to compensate for the image data such that an image is displayed with a desired or suitable luminance depending on a characteristic of the electronic device ED or user settings or may be to convert the image data to reduce power consumption or to compensate for afterimages. The gamma correction circuit 112-3 may be to convert the image data or the gamma reference voltage such that an image displayed on the electronic device ED has a desired or suitable gamma characteristic. The rendering circuit 112-4 may be to receive the image data from the controller 112-1 and may be to render the image data in consideration of a pixel arrangement of the display panel 141 applied to the electronic device ED. At least one selected from among the data conversion circuit 112-2, the gamma correction circuit 112-3, and the rendering circuit 112-4 may be integrated into any other component (e.g., the main processor 111 or the controller 112-1). At least one selected from among the data conversion circuit 112-2, the gamma correction circuit 112-3, and the rendering circuit 112-4 may be integrated into a data driver 143 to be described in more detail herein.

The memory 120 may be to store one or more suitable data used by at least one component (e.g., the processor 110 or the sensor module 161) of the electronic device ED and input data or output data for commands related thereto. The memory 120 may include at least one selected from the volatile memory 121 and the nonvolatile memory 122.

The input module 130 may be to receive a command or data to be used by a component (e.g., the processor 110, the sensor module 161, or the sound output module 163) of the electronic device ED from the outside of the electronic device ED (e.g., the user or the external electronic device 102).

The input module 130 may include a first input module 131 to which a command or data are input from the user and a second input module 132 to which a command or data are input from the external electronic device 102. The first input module 131 may include a microphone, a mouse, a keyboard, a key (e.g., a button), or a pen (e.g., a passive pen or an active pen). The second input module 132 may be to support a specified protocol capable of connecting to the external electronic device 102 by wire or wirelessly. According to one or more embodiments, the second input module 132 may include a high definition multimedia interface (HDMI), a universal serial bus (USB) interface, a secure digital (SD) card interface, and/or an audio interface. The second input module 132 may include a connector capable of being physically connected with the external electronic device 102, for example, an HDMI connector, a USB connector, an SD card connector, and/or an audio connector (e.g., a headphone connector).

The display module 140 may be to visually provide information to the user. The display module 140 may include the display panel 141, a scan driver 142, and the data driver 143. The display module 140 may further include a window, a chassis, and a bracket to protect the display panel 141.

The display panel 141 may include a liquid crystal display panel, an organic light emitting display panel, and/or an inorganic light emitting display panel, and the type (kind) of the display panel 141 is not particularly limited. The display panel 141 may be of a rigid type (kind) or may be of a flexible type (kind) capable of being rolled or folded. The display module 140 may further include a supporter that is to support the display panel 141, a bracket, or a heat radiating member.

The scan driver 142 may be mounted on the display panel 141 as a driver chip. In one or more embodiments, the scan driver 142 may be integrated into the display panel 141. For example, the scan driver 142 may include an amorphous (e.g., non-crystalline) silicon TFT gate driver circuit (ASG), a low temperature polycrystalline silicon (LTPS) TFT gate driver circuit, or an oxide semiconductor TFT gate driver circuit (OSG) embedded in the display panel 141. The scan driver 142 may be to receive a control signal from the controller 112-1 and output scan signals to the display panel 141 in response to the control signal.

The display panel 141 may further include an emission driver. The emission driver may be to output an emission control signal to the display panel 141 in response to a control signal received from the controller 112-1. The emission driver may be formed or arranged separately from the scan driver 142 or may be integrated into the scan driver 142.

The data driver 143 may be to receive a control signal from the controller 112-1, convert image data into analog voltages (e.g., data voltages) in response to the control signal, and output the data voltages to the display panel 141.

The data driver 143 may be integrated into another component (e.g., the controller 112-1). The functions of the interface conversion circuit and the timing control circuit of the controller 112-1 as described in one or more embodiments may be integrated into the data driver 143.

The display module 140 may further include the emission driver and a voltage generation circuit. The voltage generation circuit may be to output one or more suitable types (kinds) of voltages desired or required to drive the display panel 141.

The power supply module 150 may be to supply power to the components of the electronic device ED. The power supply module 150 may include a battery that charges a power supply voltage. The battery may include a primary cell designed to be not rechargeable, a secondary cell that is designed to be rechargeable, and/or a fuel cell. The power supply module 150 may include a power management integrated circuit (PMIC). The PMIC may be to supply power improved or optimized for each of the modules as described in one or more embodiments and modules to be described in more detail herein. The power supply module 150 may include a wireless power transmission/reception member electrically connected with the battery. The wireless power transmission/reception member may include a plurality of antenna radiators that are in the form of a coil.

The electronic device ED may further include the internal module 160 and the external module 170. The internal module 160 may include the sensor module 161, the antenna module 162, and the sound output module 163. The external module 170 may include the camera module 171, a light module 172, and the communication module 173.

The sensor module 161 may be to sense an input by a user's body and/or an input by a pen among the first input module 131 and may be to generate an electrical signal or a data value corresponding to the input. The sensor module 161 may include at least one selected from among the fingerprint sensor 161-1, the input sensor 161-2, and a digitizer 161-3.

The fingerprint sensor 161-1 may be to generate a data value corresponding to the user's fingerprint. The fingerprint sensor 161-1 may include one of an optical fingerprint sensor or a capacitive fingerprint sensor.

The input sensor 161-2 may be to generate a data value corresponding to coordinate information of the input by the user's body and/or the input by the pen. The input sensor 161-2 may be to generate a capacitance change due to the input as a data value. The input sensor 161-2 may be to sense the input by the passive pen or may be to exchange data with the active pen.

The input sensor 161-2 may be to measure a biometric signal, such as blood pressure, moisture, and/or body fat. For example, if (e.g., when) the user touches his/her body part to a sensor layer or a sensing panel and does not move during a given time period, the input sensor 161-2 may detect the biometric signal based on a change in an electric field caused by the body part and may output the information desired or suitable by the user to the display module 140.

The digitizer 161-3 may be to generate a data value corresponding to the coordinate information of the input by the pen. The digitizer 161-3 may be to generate the amount of electromagnetic change by the input as a data value. The digitizer 161-3 may be to sense the input by the passive pen or may exchange data with the active pen.

At least one selected from among the fingerprint sensor 161-1, the input sensor 161-2, and the digitizer 161-3 may be implemented with a sensor layer on the display panel 141 through a substantially continuous process. The fingerprint sensor 161-1, the input sensor 161-2, and the digitizer 161-3 may be arranged above/on the display panel 141, and one selected from among the fingerprint sensor 161-1, the input sensor 161-2, and the digitizer 161-3, for example, the digitizer 161-3, may be arranged below/under the display panel 141.

At least two selected from among the fingerprint sensor 161-1, the input sensor 161-2, and the digitizer 161-3 may be integrally formed or arranged with one sensing panel through substantially the same process. If (e.g., when) they are integrally formed or arranged with one sensing panel, the sensing panel may be arranged between the display panel 141 and the window arranged above/on the display panel 141. According to one or more embodiments, the sensing panel may be arranged on the window, and the location of the sensing panel is not particularly limited.

At least one selected from among the fingerprint sensor 161-1, the input sensor 161-2, and the digitizer 161-3 may be embedded in the display panel 141. For example, at least one selected from among the fingerprint sensor 161-1, the input sensor 161-2, and the digitizer 161-3 may be concurrently (e.g., simultaneously) formed or arranged through a process of forming or arranging elements (e.g., a light emitting element and transistors) included in the display panel 141.

In one or more embodiments, the sensor module 161 may be to generate an electrical signal or a data value corresponding to an internal state or an external state of the electronic device ED. The sensor module 161 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The antenna module 162 may include one or more antennas to transmit or receive the signal or power to or from an external source. According to one or more embodiments, through an antenna suitable for a communication method, the communication module 173 may be to transmit a signal to an external electronic device or may be to receive a signal from the external electronic device. An antenna pattern of the antenna module 162 may be integrated with one component (e.g., the display panel 141) of the display module 140 or the input sensor 161-2.

The sound output module 163 that is a device to output a sound signal to the outside of the electronic device ED may include, for example, a speaker used for general purposes, such as multimedia playback or recording playback, and a receiver used exclusively to receive calls. According to one or more embodiments, the receiver and the speaker may be either integrally or separately implemented. A sound output pattern of the sound output module 163 may be integrated with the display module 140.

The camera module 171 may be to image a still image and/or a moving image. According to one or more embodiments, the camera module 171 may include one or more lenses, an image sensor, or an image signal processor. The camera module 171 may further include an infrared camera capable of measuring the presence or absence of the user, the location of the user, and the line of sight of the user.

The light module 172 may be to provide light. The light module 172 may include a light emitting diode and/or a xenon lamp. The light module 172 may be to operate in conjunction with the camera module 171 or may be to operate independently.

The communication module 173 may be to establish a wired communication channel or a wireless communication channel between the electronic device ED and the external electronic device 102 and may be to support communication execution through the established communication channel. The communication module 173 may include one selected from among a wireless communication module, such as a cellular communication module, a short-range wireless communication module, or a global navigation satellite system (GNSS) communication module, and a wired communication module, such as a local area network (LAN) communication module or a power line communication module, or may include all thereof. The communication module 173 may be to communicate with the external electronic device 102 over a short-range communication network, such as Bluetooth, Wi-Fi direct, or infrared data association (IrDA), or a long-range communication network, such as a cellular network, an Internet, or a computer network (e.g., a LAN or WAN). One or more suitable types or kinds of communication modules as described herein may be implemented with one chip or with separate chips, respectively.

The input module 130, the sensor module 161, the camera module 171, and/or the like may be used to control the operation of the display module 140 in conjunction with the processor 110.

The processor 110 may be to output commands or data to the display module 140, the sound output module 163, the camera module 171, or the light module 172 based on the input data received from the input module 130. For example, the processor 110 may be to generate the image data corresponding to the input data applied through the mouse or the active pen and may be to output the image data to the display module 140. In one or more embodiments, the processor 110 may be to generate command data corresponding to the input data and may be to output the command data to the camera module 171 or the light module 172. If (e.g., when) input data are not received from the input module 130 during a given time period, the processor 110 may switch an operating mode of the electronic device ED to a low-power mode or a sleep mode such that the power consumption of the electronic device ED is reduced.

The processor 110 may be to output commands or data to the display module 140, the sound output module 163, the camera module 171, or the light module 172 based on the sensing data received from the sensor module 161. For example, the processor 110 may be to compare authentication data obtained through the fingerprint sensor 161-1 with authentication data stored in the memory 120 and may then be to execute an application depending on a comparison result. The processor 110 may be to execute a command based on the sensing data sensed by the input sensor 161-2 or the digitizer 161-3 or may be to output image data corresponding to the sensing data to the display module 140. If (e.g., when) the sensor module 161 includes a temperature sensor, the processor 110 may receive temperature data associated with the measured temperature from the sensor module 161 and may further perform luminance correction on the image data based on the temperature data.

The processor 110 may be to receive measurement data about the presence or absence of the user, the location of the user, and the line of sight of the user from the camera module 171. The processor 110 may further be to perform the luminance correction on the image data based on the measurement data. For example, the processor 110 that determines the presence or absence of the user through the input from the camera module 171 may be to output, to the display module 140, image data whose luminance is corrected through the data conversion circuit 112-2 or the gamma correction circuit 112-3.

One or more of the components as described in one or more embodiments may be connected with each other through a communication scheme between peripheral devices, for example, a bus, a general purpose input/output (GPIO), a serial peripheral interface (SPI), a mobile industry processor interface (MIPI), or an ultra path interconnect (UPI) link and may be to exchange signals (e.g., commands or data). The processor 110 may be to communicate with the display module 140 through a given interface. For example, one of the communication methods as described in one or more embodiments may be used, and embodiments of the present disclosure are not limited thereto.

The electronic device ED according to one or more embodiments of the present disclosure may be implemented as one or more suitable types (kinds) of devices. The electronic device ED may include, for example, at least one selected from among a portable communication device (e.g., a smart phone), a tablet device, a portable multimedia device, a wearable device, and home appliances. The electronic device ED according to one or more embodiments of the present disclosure is not limited to the devices as described in one or more embodiments. AR glasses as illustrated in FIG. 1B, one or more suitable types (kinds) of vehicle display devices as illustrated in FIG. 1C, and a smart watch as illustrated in FIG. 1D may be implemented as the electronic device of the present disclosure.

Referring to FIGS. 2A to 2C, the electronic device ED may include a display surface FS defined by a first direction DR1 and a second direction DR2 crossing the first direction DR1. The electronic device ED may be to provide an image IM to a user through the display surface FS. The image IM may be provided in a third direction DR3.

The display surface FS of the electronic device ED according to one or more embodiments may include a display area F-AA and a peripheral area F-NAA. The electronic device ED may be to display the image IM through the display area F-AA. The peripheral area F-NAA may be adjacent to the display area F-AA. The peripheral area F-NAA may not be to display the image IM and may have a certain (e.g., set or predetermined) color. The peripheral area F-NAA may be around (e.g., surround) the display area F-AA. However, without being limited thereto, the peripheral area F-NAA may be arranged adjacent to only one side of the display area F-AA or may not be provided. The electronic device ED according to one or more embodiments of the present disclosure may include active areas having one or more suitable shapes and is not limited to any one or more embodiments.

The display surface FS may further include a sensing area EMA. One or more suitable electronic modules may be arranged in the sensing area EMA. For example, the electronic modules may include at least one selected from among a camera module, a light detection sensor, and a heat detection sensor. The sensing area EMA may be around (e.g., surrounded) by the display area F-AA. Although one sensing area EMA is illustrated as an example, the number of sensing areas EMA is not limited thereto.

The sensing area EMA may be a portion of the display area F-AA. Accordingly, the sensing area EMA may also be to display the image IM. For example, if (e.g., when) the electronic modules arranged in the sensing area EMA are deactivated, the sensing area EMA may display the image IM as a portion of the display area F-AA.

The electronic device ED and/or the display surface FS may include a folding area FA and non-folding areas NFA1 and NFA2. The electronic device ED may include the plurality of non-folding areas NFA1 and NFA2. The electronic device ED of one or more embodiments may include the first non-folding area NFA1 and the second non-folding area NFA2 arranged with the folding area FA therebetween. In one or more embodiments, although FIGS. 2A to 2C illustrate one or more embodiments of the electronic device ED including one folding area FA, embodiments of the present disclosure are not limited thereto, and the electronic device ED may include a plurality of folding areas.

Referring to FIGS. 2B and 2C, the electronic device ED may be folded with respect to a folding axis FX extending in one direction. The folding axis FX as illustrated in FIGS. 2B and 2C may be a virtual axis extending in the second direction DR2. The folding axis FX may be defined to overlap the folding area FA and may be parallel (e.g., substantially parallel) to the direction of the long sides of the electronic device ED.

Referring to FIG. 2B, the electronic device ED may be folded such that the first non-folding area NFA1 and the second non-folding area NFA2 are opposite to (e.g., face) each other. For example, the electronic device ED may be folded in an in-folding manner such that the display surface FS is not exposed to the outside. Referring to FIG. 2C, the electronic device ED according to one or more embodiments of the present disclosure may be folded in an out-folding manner such that the display surface FS is exposed to the outside.

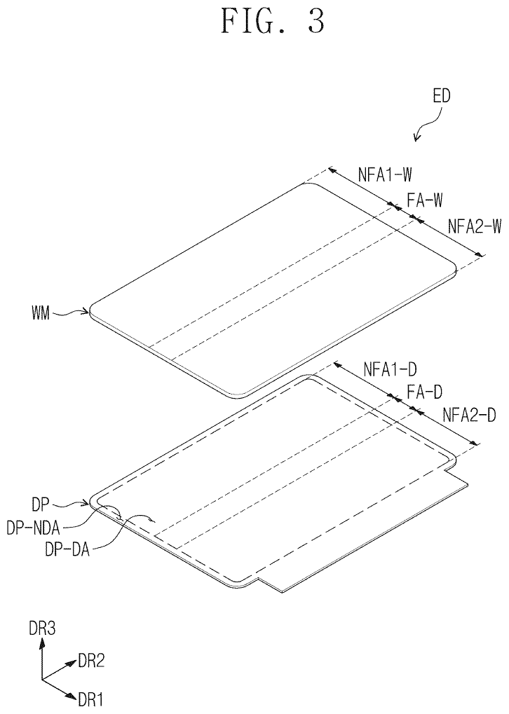

FIG. 3 is an exploded perspective view of the electronic device ED according to one or more embodiments of the present disclosure.

The electronic device ED according to one or more embodiments of the present disclosure may include a display panel DP and a window WM arranged on the display panel DP.

The display panel DP may be an emissive display panel. For example, the display panel DP may be an organic light emitting display panel, an inorganic light emitting display panel, a micro LED display panel, a micro OLED display panel, and/or a nano LED display panel.

The display panel DP may include a display area DP-DA and a non-display area DP-NDA. The display area DP-DA may be an area where pixels are arranged. The display area DP-DA may be to generate the image IM as described with reference to FIGS. 2A to 2C. The display area DP-DA of the display panel DP may correspond to the display area F-AA as described with reference to FIGS. 2A to 2C. The non-display area DP-NDA may correspond to the peripheral area F-NAA as described with reference to FIGS. 2A to 2C. In the present disclosure, the expression “one area (e.g., portion) corresponds to another area (e.g., portion)” is sufficient or suitable if (e.g., when) the areas overlap each other and is not limited to substantially the same shape and substantially the same area.

The display panel DP may include a folding area FA-D, a first non-folding area NFA1-D, and a second non-folding area NFA2-D that correspond to the folding area FA, the first non-folding area NFA1, and the second non-folding area NFA2 of the electronic device ED, respectively.

The window WM may provide the display surface FS as described with reference to FIGS. 2A to 2C. For example, the window WM may provide the front surface of the electronic device ED. The window WM may include a folding area FA-W, a first non-folding area NFA1-W, and a second non-folding area NFA2-W that correspond to the folding area FA, the first non-folding area NFA1, and the second non-folding area NFA2 of the electronic device ED, respectively.

The window WM may include a base substrate and a bezel pattern arranged on one surface of the base substrate. The area where the bezel pattern is arranged may define the peripheral area F-NAA as described with reference to FIGS. 2A to 2C. In one or more embodiments of the present disclosure, the bezel pattern may not be provided.

In FIG. 3, one or more components of the electronic device ED, such as the display panel DP and the window WM, are illustrated. For example, the electronic device ED may further include a protective layer arranged on the window WM, an input sensor arranged between the window WM and the display panel DP, and a support plate, a cushion layer, an electronic module, and a housing that are arranged under the display panel DP. The electronic module arranged under the display panel DP may include the processor 110, the memory 120, and the power supply module 150 as described with reference to FIG. 1A. In one or more embodiments, the electronic device ED may further include the other components as described with reference to FIGS. 2A to 2C.

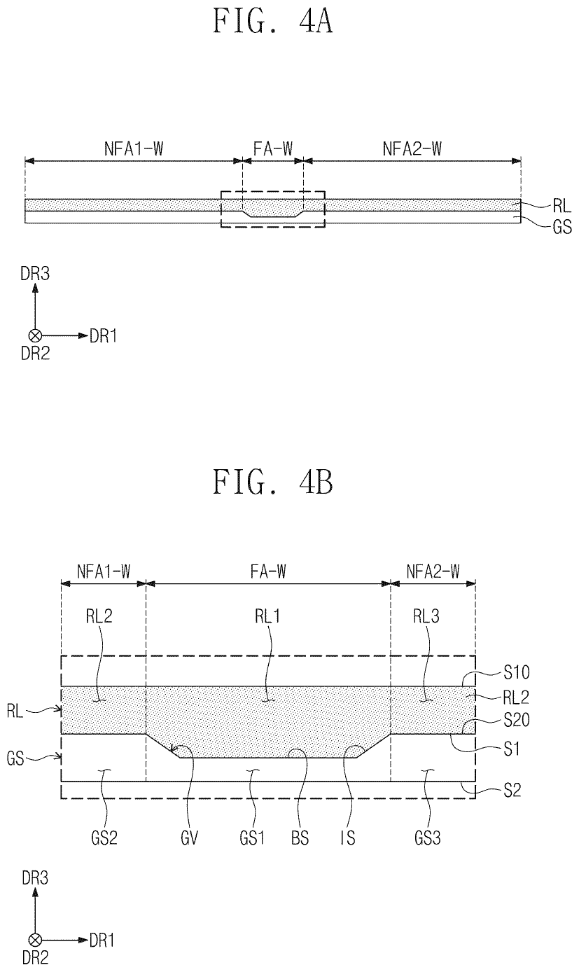

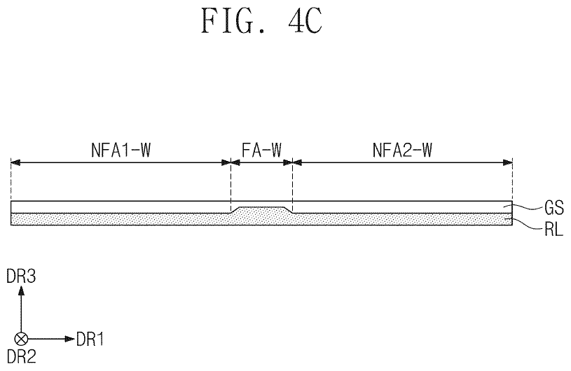

FIG. 4A is a sectional view of the window WM according to one or more embodiments of the present disclosure. FIG. 4B is an enlarged sectional view of a portion of FIG. 4A. FIG. 4C is a sectional view of the window WM according to one or more embodiments of the present disclosure.

Referring to FIGS. 4A and 4B, the window WM may include a glass substrate GS and a resin layer RL arranged on one surface of the glass substrate GS. The glass substrate GS may be a chemically strengthened glass substrate. The resin layer RL may include an acrylic resin, an epoxy resin, a silicone resin, a urethane resin, a urethane acrylic resin, a hybrid sol-gel resin, and/or a siloxane-based resin. The window WM having the structure as described in one or more embodiments may have improved or enhanced impact resistance through the resin layer RL while maintaining the optical properties and design properties of the glass substrate GS.

The glass substrate GS may include a first surface S1 and a second surface S2 opposite to (e.g., facing) each other in the third direction DR3, and the resin layer RL may include a first surface S10 and a second surface S20 opposite to (e.g., facing) each other in the third direction DR3. In FIGS. 4A and 4B, the first surface S1 of the glass substrate GS is illustrated as the upper surface of the glass substrate GS, and the first surface S10 of the resin layer RL is illustrated as the upper surface of the resin layer RL. The first surface S10 of the resin layer RL may be the upper surface of the window WM. The first surface S1 of the glass substrate GS and the second surface S20 of the resin layer RL may make contact with each other.

The glass substrate GS and the resin layer RL may have different thicknesses depending on areas. A first portion GS1 of the glass substrate GS that corresponds to the folding area FA-W may have a smaller thickness than a second portion GS2 and a third portion GS3 of the glass substrate GS that correspond to the first non-folding area NFA1-W and the second non-folding area NFA2-W. A first portion RL1 of the resin layer RL that corresponds to the folding area FA-W may have a greater thickness than a second portion RL2 and a third portion RL3 of the resin layer RL that correspond to the first non-folding area NFA1-W and the second non-folding area NFA2-W.

The first portion GS1 of the glass substrate GS may be an area where a groove GV extending in a direction parallel (e.g., substantially parallel) to the folding axis FX of FIGS. 2B and 2C is formed or arranged. The groove GV may have a substantially constant width in the first direction DR1 and may extend in the second direction DR2.

The first portion RL1 of the resin layer RL may fill the groove GV. The second surface S2 of the glass substrate GS may provide a flat surface (e.g., a substantially flat surface), and the first surface S10 of the resin layer RL may provide a flat surface (e.g., a substantially flat surface). Accordingly, the window WM may have a substantially uniform thickness.

The shape of the groove GV on the cross-section is not particularly limited. FIG. 4B illustrates the groove GV defined by a flat bottom surface BS and two inclined surfaces IS having bilateral symmetry. The bottom surface BS and the two inclined surfaces IS may be different portions of the first surface S1 of the glass substrate GS.

According to the present disclosure, the positions of the glass substrate GS and the resin layer RL are not limited to one or more embodiments of the window WM as illustrated in FIGS. 4A and 4B. FIG. 4C illustrates the window WM in which the glass substrate GS and the resin layer RL are turned upside down if (e.g., when) compared to those of the window WM as illustrated in FIGS. 4A and 4B.

In one or more embodiments of the present disclosure, the stacked structure of the window WM may be modified. In one or more embodiments of the present disclosure, the resin layer RL may not be provided. In one or more embodiments of the present disclosure, the resin layer RL may be replaced with an adhesive layer, such as a pressure sensitive adhesive sheet. A protective film may be additionally arranged on the adhesive layer.

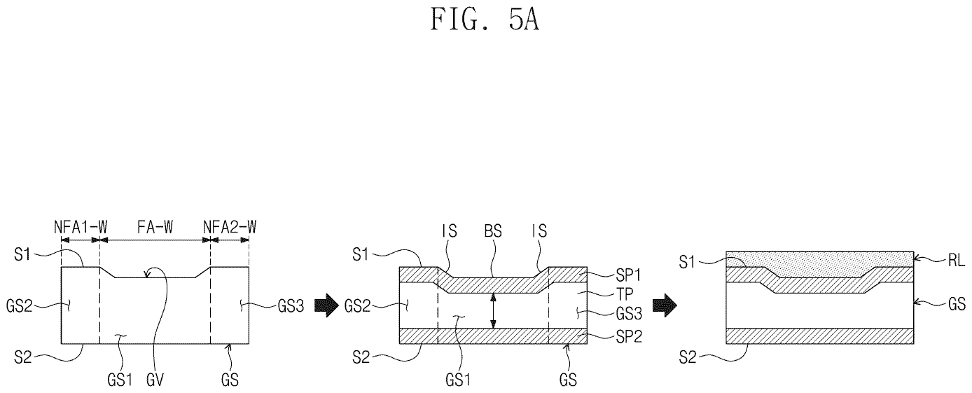

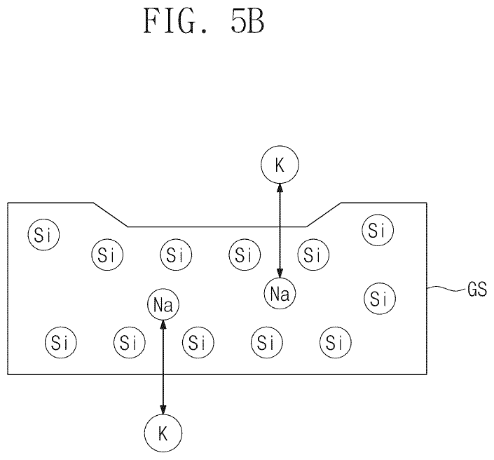

FIG. 5A is a sectional view illustrating a method of manufacturing the window WM according to one or more embodiments of the present disclosure. FIG. 5B illustrates a chemical strengthening method of the glass substrate GS.

In FIGS. 5A and 5B, the glass substrate GS is illustrated based on FIG. 4B. More detailed description of components that are substantially identical to the components as described with reference to FIGS. 4A to 4C may not be provided, and reference will be made to the description of FIGS. 4A to 4C.

As illustrated in FIG. 5A, the groove GV may be formed or arranged on the glass substrate GS. The groove GV may be formed or arranged on one surface of the glass substrate GS having a substantially constant thickness using a chemical etching method and/or a mechanical processing method.

Next, chemical strengthening may be performed on the glass substrate GS having the groove GV formed or arranged thereon. The chemical strengthening may include an ion exchange method. Substantially the same chemical strengthening may be performed on the first portion GS1, the second portion GS2, and the third portion GS3. A tensile stress area TP and compressive stress areas SP1 and SP2 may be formed or arranged in the glass substrate GS. The first compressive stress area SP1 and the second compressive stress area SP2 may be formed or arranged on the opposite sides of the tensile stress area TP in the third direction DR3. The first compressive stress region (SP1) may have a first depth from the first surface (S1), and the second compressive stress region (SP2) may have a second depth from the second surface (S2). Because substantially the same chemical strengthening is performed on the first surface S1 and the second surface S2, the first compressive stress area SP1 and the second compressive stress area SP2 on the opposite sides may have substantially the same thickness and/or substantially the same depth. For example, the first depth and the second depth may be substantially the same.

FIG. 5B schematically illustrates the ion exchange method. The glass substrate GS having the groove GV formed or arranged thereon may be chemically strengthened using a salt (e.g., a liquid ionic salt) containing certain or suitable ionic salts. A plurality of potassium ions (K⁺) may be provided to the glass substrate GS. Accordingly, the glass substrate GS may include a medium and sodium ions (Na⁺) and potassium ions (K⁺) dispersed in the medium. The potassium ions (K⁺) may be substituted for the sodium ions (Na⁺) dispersed in the medium and may be absorbed into the glass substrate GS from the ionic salt.

The magnitude of surface stress (e.g., surface compressive stress), the magnitude of internal stress (e.g., internal tensile stress), and the depth of the compressive stress areas SP1 and SP2, for example, the depth of layer (DOL) may be determined depending on the degree of substitution of the potassium ions (K⁺) and the sodium ions (Na⁺). In one or more embodiments, the magnitude of surface stress (e.g., surface compressive stress), the magnitude of internal stress (e.g., internal tensile stress), and the depth of the compressive stress areas SP1 and SP2, for example, the depth of layer (DOL) may be determined depending on one or more suitable chemical strengthening methods of the glass substrate GS. The magnitude of surface stress (e.g., surface compressive stress) and the depth of layer (DOL) may be determined by ion exchange time and ion exchange temperature.

Then, as illustrated in FIG. 5A, the resin layer RL may be formed or arranged on the first surface S1 of the glass substrate GS. In one or more embodiments of the present disclosure, the resin layer RL may be formed or arranged by coating the first surface S1 of the glass substrate GS with a liquid resin and thereafter drying the liquid resin.

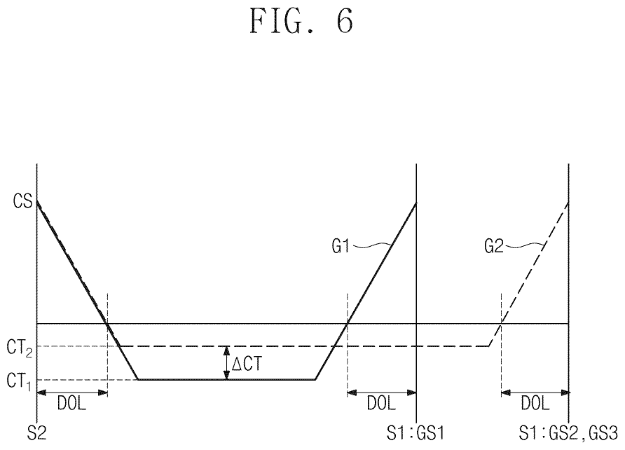

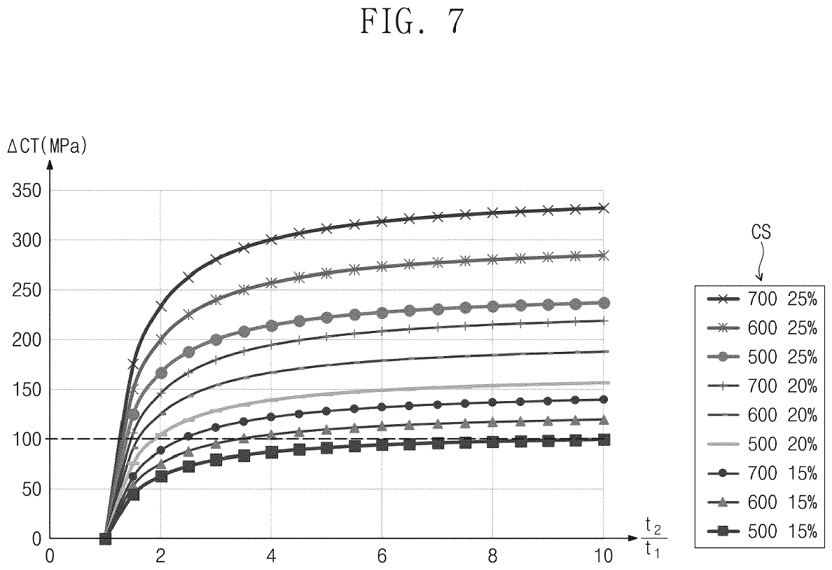

FIG. 6 is a graph depicting a change in the stress of the glass substrate GS according to one or more embodiments of the present disclosure. FIG. 7 is a graph depicting an internal stress difference (ΔCT) (e.g., an internal tensile stress difference) between a first point and a second point of the glass substrate versus the ratio between the thickness t₁ of the first point and the thickness t₂ of the second point according to one or more embodiments of the present disclosure.

As described with reference to FIGS. 5A and 5B, the chemically strengthened glass substrate GS may include the first compressive stress area SP1, the second compressive stress area SP2, and the tensile stress area TP defined therebetween in the thickness direction. In one or more embodiments, the second portion GS2 and the third portion GS3 may include substantially the same first compressive stress area SP1, substantially the same second compressive stress area SP2, and substantially the same tensile stress area TP, and therefore the following description will be focused on the second portion GS2.

The first graph G1 of FIG. 6 represents a change in the stress of the first portion GS1 (refer to FIG. 5A), and the second graph G2 represents a change in the stress of the second portion GS2 (refer to FIG. 5A).

Referring to FIG. 5A and the first graph G1 of FIG. 6, compressive stress CS may occur on the first surface S1 and the second surface S2 of the first portion GS1. This stress may be defined as surface compressive stress. The magnitude of the compressive stress may decrease toward the inside of the first portion GS1 from the first surface S1 and the second surface S2. For example, the compressive stress may linearly decrease.

The compressive stress may not substantially act at a certain (e.g., set or predetermined) depth, and the depth may be defined as the depth of layer (DOL). Tensile stress may occur at the inside of the first portion GS1 deeper than the depth of layer (DOL). The tensile stress may increase as the distance from the first surface S1 or the second surface S2 increases. For example, the tensile stress may linearly increase. The tensile stress may have a maximum value at a certain (e.g., set or predetermined) depth. The tensile stress may no longer increase and may substantially remain in equilibrium at the certain (e.g., set or predetermined) depth. The expression “the tensile stress substantially remains in equilibrium” used herein is not necessarily limited to substantially the same value. The tensile stress may be considered to be in a substantially equilibrium state in the depth range in which the amount of change in the tensile stress is significantly small if (e.g., when) compared to that in the section where the tensile stress increases.

The tensile stress in the substantially equilibrium state may be defined as internal tensile stress CT. The areas where the compressive stress acts in the first portion GS1 may be the first compressive stress area SP1 and the second compressive stress area SP2 as described with reference to FIG. 5A, and the area where the tensile stress acts in the first portion GS1 may be the tensile stress area TP as described with reference to FIG. 5A.

Referring to the second graph G2, even in the case of the second portion GS2, compressive stress may act on the first surface S1 and the second surface S2, and tensile stress may act in the area having a depth greater than the depth of layer DOL.

Because substantially the same chemical strengthening is performed on the first portion GS1 and the second portion GS2 as described with reference to FIGS. 5A and 5B, the first portion GS1 and the second portion GS2 may have substantially the same magnitude of surface compressive stress CS. In one or more embodiments, the first portion GS1 and the second portion GS2 may have substantially the same depth of layer (DOL).

Because the second portion GS2 is thicker than the first portion GS1, the second portion GS2 may have a thicker tensile stress area TP than the first portion GS1. Because the second portion GS2 has the thicker tensile stress area TP than the first portion GS1, the second portion GS2 may have a relatively small internal tensile stress CT. Because tensile stress occurring at one point of the first portion GS1 and tensile stress occurring at one point of the second portion GS2 are substantially the same as each other, the internal tensile stress CT may be small if (e.g., when) the thickness of the tensile stress area is large. If (e.g., when) the tensile stress occurring at one point of the first portion GS1 and the tensile stress occurring at one point of the second portion GS2 are substantially the same as each other, this may refer to that the area under the depth of layer (DOL) of the first graph G1 and the area under the depth of layer (DOL) of the second graph G2 are substantially the same as each other.

For example, the first portion GS1 may have a first internal tensile stress CT₁, and the second portion GS2 may have a second internal tensile stress CT₂ at most (e.g., equal to or less than) the first internal tensile stress CT₁. The first internal tensile stress CT₁ may have a maximum value at a point (hereinafter, referred to as the first reference point) of the first portion GS1 having a minimum thickness. Referring to FIG. 5A, one point in the bottom surface BS may have a greater first internal tensile stress CT₁ than one point in the inclined surface IS.

The second internal tensile stress CT₂ may have a minimum value at a point (hereinafter, referred to as the second reference point) of the second portion GS2 having a maximum thickness. Because the second portion GS2 has substantially the same thickness, the second portion GS2 may have substantially the same second internal tensile stress CT₂ irrespective of a measurement point.

As a result, the difference (ΔCT) in the internal tensile stress CT between the first portion GS1 and the second portion GS2 may occur. The maximum value of the difference (ΔCT) in the internal tensile stress CT may occur between the first reference point and the second reference point.

If (e.g., when) the first portion GS1 has a greater internal tensile stress CT than the second portion GS2, this refers to that a property of expanding in the tensile stress area TP of the first portion GS1, which has a smaller area than the tensile stress area TP of the second portion GS2, may be greater than that in tensile stress area TP of the second portion GS2. It refers to that as the difference (ΔCT) in the internal tensile stress CT is increased, a property of expanding in the tensile stress area TP of the first portion GS1 may be greater than that in the tensile stress area TP of the second portion GS2.

Table 1 shows the occurrence or non-occurrence of distortion of the first portion GS1 depending on the examples.

TABLE 1

| | First Portion GS1 - 30 μm | | | Second Portion GS2 - 50 μm | | | Distortion of |
|---|---|---|---|---|---|---|---|
| | CS1 | DOL | CT1 | CS2 | DOL | CT2 | First Portion |
| | (MPa) | (μm) | (MPa) | (MPa) | (μm) | (MPa) | GS1 |
| Experimental | 585 | 5.5 | 167 | 581 | 5.4 | 53 | Occurrence |
| Example 1 | | | | | | | |
| Experimental | 565 | 5.5 | 163 | 546 | 5.5 | 50 | Occurrence |
| Example 2 | | | | | | | |
| Experimental | 554 | 5.4 | 156 | 542 | 5.4 | 50 | Occurrence |
| Example 3 | | | | | | | |
| Experimental | 533 | 5.5 | 152 | 528 | 5.4 | 48 | Occurrence |
| Example 4 | | | | | | | |
| Experimental | 541 | 5.5 | 155 | 538 | 5.5 | 50 | Occurrence |
| Example 5 | | | | | | | (Slight |
| | | | | | | | Distortion) |
| Experimental | 519 | 5.5 | 151 | 521 | 5.5 | 48 | Non- |
| Example 6 | | | | | | | occurrence |

According to Table 1, in Experimental Examples 1 to 6, the surface compressive stress CS₁ (hereinafter, referred to as the first surface compressive stress) was measured at the first reference point where the minimum thickness of the first portion GS1 was 30 μm, and the surface compressive stress CS₂ (hereinafter, referred to as the second surface compressive stress) was measured at the second reference point where the maximum thickness of the second portion GS2 was 50 μm. The internal tensile stress CT₁ (hereinafter, referred to as the first internal tensile stress) was calculated at the first reference point, and the internal tensile stress CT₂ (hereinafter, referred to as the second internal tensile stress) was calculated at the second reference point. In one or more embodiments, the depth of layer (DOL) of the first portion GS1 and the depth of layer (DOL) of the second portion GS2 were measured.

In Experimental Examples 1 to 6, the chemical strengthening was performed such that the first portion GS1 and the second portion GS2 had substantially the same depth of layer (DOL). The first portion GS1 and the second portion GS2 had substantially the same depth of layer (DOL).

The glass substrates were chemically strengthened under different chemical strengthening conditions such that the first surface compressive stress CS₁ and the second surface compressive stress CS₂ varied depending on the examples. For example, if (e.g., when) chemical strengthening is performed at a relatively low temperature, a relatively long chemical strengthening time is desired or required to achieve a desired or suitable depth of layer (DOL). If (e.g., when) the chemical strengthening is performed under such conditions, a chemically strengthened glass substrate having a relatively high first surface compressive stress CS₁ and a relatively high second surface compressive stress CS₂ may be manufactured. In contrast, if (e.g., when) chemical strengthening is performed at a relatively high temperature, a relatively short chemical strengthening time is desired or required to achieve a desired or suitable depth of layer (DOL). As a result, the first surface compressive stress CS₁ and the second surface compressive stress CS₂ may be lowered. If (e.g., when) the chemical strengthening temperature is changed to achieve the desired or suitable depth of layer (DOL) as described in one or more embodiments, the chemical strengthening time may vary. The first surface compressive stress CS₁ and the second surface compressive stress CS₂ may vary under the different chemical strengthening conditions.

In each of Experimental Examples 1 to 6, the first surface compressive stress CS₁ and the second surface compressive stress CS₂ may be substantially the same as each other. This is because the first portion GS1 and the second portion GS2 were chemically strengthened in substantially the same way in one Experimental Example. In Table 1, it can be seen that there is a slight error in the first surface compressive stress CS₁ and the second surface compressive stress CS₂ due to the influence of the experimental environment.

Referring to Table. 1, it can be seen that the difference (ΔCT) in the internal tensile stress CT in Experimental Example 6 is relatively small if (e.g., when) compared to those in Experimental Examples 1 to 5 and distortion of the first portion GS1 does not occur in Experimental Example 6. If (e.g., when) the difference (ΔCT) in the internal tensile stress CT is small, the tensile stress area TP of the first portion GS1 may expand relatively small, and accordingly distortion of the first portion GS1 may not occur. Through Experimental Example 6, it can be seen that if (e.g., when) the difference (ΔCT) in the internal tensile stress CT is 103 MPa, distortion of the first portion GS1 may not occur. Based on this, it can be more reliably ensured that if (e.g., when) the difference (ΔCT) in the internal tensile stress CT is 100 MPa or less, distortion of the first portion GS1 may not occur.

The first graph G1 of FIG. 6 is obtained by measuring a stress change at one point of the first portion GS1, and the second graph G2 of FIG. 6 is obtained by measuring a stress change at one point of the second portion GS2. The one point of the first portion GS1 may be the first reference point as described in one or more embodiments. The one point of the second portion GS2 may be the second reference point as described in one or more embodiments.

The difference (ΔCT) in internal tensile stress between the first reference point and the second reference point may be calculated by Equations 1A and 1.

In Experimental Example 6, one glass substrate having an internal tensile stress difference (ΔCT) of 100 MPa or less has been described. However, according to the present disclosure, the glass substrate is not limited thereto.

Even though a glass substrate satisfying the condition that the internal tensile stress difference (ΔCT) calculated by Equation 1A or 1 is 100 MPa or less has specifications different from those of the glass substrate of Experimental Example 6, the distortion defect as described in one or more embodiments may be suppressed or reduced.

$$Δ CT = ( \frac{{CS}_{1} \times DOL}{{t}_{1} - 2 \times DOL} ) - ( \frac{{CS}_{2} \times DOL}{{t}_{2} - 2 \times DOL} ) = ( \frac{{CS}_{1} \times {t}_{1} \times Ratio}{{t}_{1} - 2 \times {t}_{1} \times Ratio} ) - ( \frac{{CS}_{2} \times {t}_{1} \times Ratio}{{t}_{2} - 2 \times {t}_{1} \times Ratio} ) \qquad Equation 1 A$$

In Equation 1A, t₁ may be the thickness of the first reference point. t₂ may be the thickness of the second reference point. It may be assumed that the first portion GS1 and the second portion GS2 have substantially the same depth of layer (DOL).

The depth of layer (DOL) may be controlled or selected by chemical strengthening conditions and may be expressed as a ratio with respect to the thickness t₁ of the first reference point. Reorganization of Equation 1A may yield Equation 1.

$$Δ CT = ( \frac{{CS}_{1} \times 1 \times Ratio}{1 - 2 \times 1 \times Ratio} ) - ( \frac{{CS}_{2} \times 1 \times Ratio}{\frac{{t}_{2}}{{t}_{1}} - 2 \times 1 \times Ratio} ) \qquad Equation 1$$

Consequently, the internal tensile stress difference (ΔCT) may be determined by the ratio between the thickness of the first reference point and the thickness of the second point, the first surface compressive stress CS₁, the second surface compressive stress CS₂, and the ratio of the depth of layer (DOL) to the thickness of the first reference point.

In one or more embodiments, the surface compressive stress CS may be in a range from 500 MPa to 700 MPa, and the ratio of the depth of layer (DOL) to the thickness of the first reference point may be in a range from 0.15 to 0.25. For example, the depth of layer (DOL) may be in a range from 15% to 25% of the thickness of the first reference point.

In the foregoing numerical range, the internal tensile stress difference (ΔCT) may be determined by the ratio between the thickness t₁ of the first reference point and the thickness t₂ of the second reference point. FIG. 7 illustrates nine graphs. In the graphs of FIG. 7, the first surface compressive stress CS₁ and the second surface compressive stress CS₂ are expressed as the surface compressive stress CS and are assumed to be equal to each other. The unit of the surface compressive stress CS is not provided, and the depth of layer (DOL) is expressed as a percentage (%) with respect to the thickness of the first reference point.

Referring to the graphs of FIG. 7, as the surface compressive stress CS increases, the internal tensile stress difference (ΔCT) may increase, and as the ratio of the depth of layer (DOL) to the thickness of the first reference point increases, the internal tensile stress difference (ΔCT) may increase.

It can be seen that the ratio between the thickness t₁ of the first reference point and the thickness t₂ of the second reference point at which distortion does not occur is limited as the surface compressive stress CS is increased or the ratio of the depth of layer (DOL) to the thickness of the first reference point is increased. If (e.g., when) the surface compressive stress CS is large or the ratio of the depth of layer (DOL) to the thickness of the first reference point is large, the difference between the thickness t₁ of the first reference point and the thickness t₂ of the second reference point has to be small such that distortion does not occur in the first portion GS1. In contrast, if (e.g., when) the surface compressive stress CS is small or the ratio of the depth of layer (DOL) to the thickness of the first reference point is small, distortion may not occur in the first portion GS1 even though the difference between the thickness t₁ of the first reference point and the thickness t₂ of the second reference point is large. This can be seen from the fact that in the graph in which the surface compressive stress CS is 500 MPa and the depth of layer (DOL) is 15% of the thickness of the first reference point, the internal tensile stress differences (ΔCT) are all less than or equal to (e.g., at most) 100 MPa irrespective of the ratio between the thickness t₁ of the first reference point and the thickness t₂ of the second reference point.

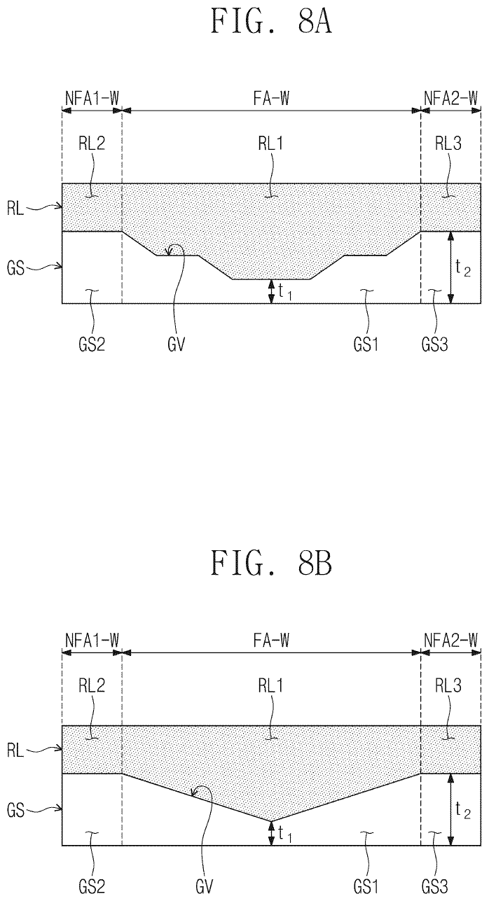

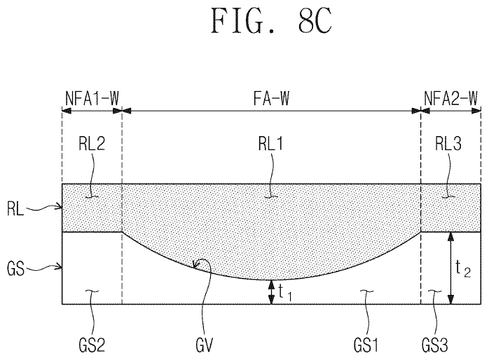

FIGS. 8A to 8C are views illustrating glass substrates GS having various shapes. The glass substrates GS as illustrated in FIGS. 8A to 8C may include a first portion GS1 having a cross-sectional shape different from that of the glass substrate GS as described in one or more embodiments.

As illustrated in FIG. 8A, the first portion GS1 may include a plurality of portions having different thicknesses. As illustrated in FIG. 8B, the first portion GS1 may include two inclined surfaces that define a groove. As illustrated in FIG. 8C, the first portion GS1 may include a concave curved surface that defines a groove. In FIGS. 8A to 8C, the thickness t₁ of a first reference point and the thickness t₂ of a second reference point are illustrated. The glass substrates GS having one or more suitable shapes, which are illustrated in FIGS. 8A to 8C, may satisfy a distortion-free condition with reference to FIGS. 5A to 7, and distortion may not occur in the first portion GS1 in a specification satisfying Equation 1A or 1.

As described in one or more embodiments, deformation (e.g., a degree or occurrence of deformation) of the glass substrate may be reduced. Furthermore, the strength of the glass substrate may be improved or enhanced, and stress (e.g., a degree or occurrence of stress) generated during folding may be reduced.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, for example, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In one or more embodiments, the impact resistance of the window may be increased or enhanced.

A display device, an electronic device, an electronic apparatus, a device for manufacturing substantially the same and/or any other relevant devices or components according to one or more embodiments of the present disclosure may be implemented by utilizing any suitable hardware, firmware (e.g., an application-specific integrated circuit), software, or a (e.g., any suitable) combination of software, firmware, and hardware. For example, the one or more components of the device may be provided on one integrated circuit (IC) chip or on separate IC chips. Further, the one or more components of the device may be implemented on a flexible printed circuit film, a tape carrier package (TCP), and/or a printed circuit board (PCB), or provided on one substrate. Further, the one or more components of the device may be a process or thread, running on one or more processors, in one or more computing devices, executing computer program instructions and interacting with other system components for performing the one or more functionalities described herein. The computer program instructions may be stored in a memory which may be implemented in a computing device utilizing a standard memory device, such as, for example, a random access memory (RAM). The computer program instructions may also be stored in other non-transitory computer readable media, such as, for example, a CD-ROM, flash drive, and/or the like. Also, a person of skill in the art should recognize that the functionality of one or more computing devices may be combined or integrated into a single computing device, or the functionality of a particular computing device may be distributed across one or more other computing devices without departing from the scope of the present disclosure.

While the subject matter of the present disclosure has been described in connection with what is presently considered to be practical example embodiments, it should be apparent to those of ordinary skill in the art that one or more suitable changes and modifications may be made thereto without departing from the spirit and scope of the present disclosure as set forth in the appended claims and equivalents thereof.

What is claimed is:

1. A glass substrate comprising:
a first portion having a groove defined thereon; and
a second portion arranged to extend from the first portion and being thicker than the first portion,
wherein each of the first portion and the second portion comprises:
a first compressive stress area having a first depth from a first surface;
a second compressive stress area having a second depth from a second surface arranged to be opposite to the first surface; and
a tensile stress area between the first compressive stress area and the second compressive stress area, and
wherein a difference (ΔCT) between internal tensile stress at a point of the first portion having a minimum thickness and internal tensile stress at a point of the second portion having a maximum thickness is at most 100 MPa.

2. The glass substrate as claimed in claim 1, wherein the first depth of the first compressive stress area of the first portion is substantially the same as the second depth of the first compressive stress area of the second portion.

3. The glass substrate as claimed in claim 1, wherein the difference (ΔCT) between the internal tensile stress at the point of the first portion having the minimum thickness and the internal tensile stress at the point of the second portion having the maximum thickness satisfies Equation 1:
$$Δ CT = ( \frac{{CS}_{1} \times 1 \times Ratio}{1 - 2 \times 1 \times Ratio} ) - ( \frac{{CS}_{2} \times 1 \times Ratio}{\frac{{t}_{2}}{{t}_{1}} - 2 \times 1 \times Ratio} ) , \qquad Equation 1$$
and
wherein, CS₁ is defined as a surface compressive stress of the first portion, CS₂ is defined as a surface compressive stress of the second portion, t₁ is defined as a thickness of the first portion, t₂ is defined as a thickness of the second portion, and Ratio is defined as a value obtained by dividing a depth of layer (DOL) of the first portion by t₁.

4. The glass substrate as claimed in claim 3, wherein the surface compressive stress of the first portion is substantially the same as the surface compressive stress of the second portion.

5. The glass substrate as claimed in claim 3, wherein the Ratio is in a range from 0.15 to 0.25.

6. The glass substrate as claimed in claim 3, wherein the surface compressive stress of the first portion and the surface compressive stress of the second portion are each in a range from 500 MPa to 700 MPa.

7. The glass substrate as claimed in claim 3, wherein the thickness of the first portion is in a range from 20 μm to 50 μm, and the thickness of the second portion is in a range from 30 μm to 300 μm.

8. A window comprising:
a glass substrate; and
a resin layer on one surface of the glass substrate,
wherein the glass substrate comprises:
a first portion on which a groove filled with the resin layer is defined; and
a second portion arranged to extend from the first portion and being thicker than the first portion,
wherein each of the first portion and the second portion comprises:
a first compressive stress area having a first depth from a first surface;
a second compressive stress area having a second depth from a second surface arranged to be opposite to the first surface; and
a tensile stress area between the first compressive stress area and the second compressive stress area, and
wherein a difference (ΔCT) between internal tensile stress at a point of the first portion having a minimum thickness and internal tensile stress at a point of the second portion having a maximum thickness is at most 100 MPa.

9. The window as claimed in claim 8, wherein the resin layer overlaps the first portion and the second portion, and
wherein a thickness of the window corresponding to the first portion is substantially the same as a thickness of the window corresponding to the second portion.

10. The window as claimed in claim 8, wherein the first depth of the first compressive stress area of the first portion is substantially the same as the second depth of the first compressive stress area of the second portion.

11. The window as claimed in claim 8, wherein the difference (ΔCT) between the internal tensile stress at the point of the first portion having the minimum thickness and the internal tensile stress at the point of the second portion having the maximum thickness satisfies Equation 1:
$$Δ CT = ( \frac{{CS}_{1} \times 1 \times Ratio}{1 - 2 \times 1 \times Ratio} ) - ( \frac{{CS}_{2} \times 1 \times Ratio}{\frac{{t}_{2}}{{t}_{1}} - 2 \times 1 \times Ratio} ) , \qquad Equation 1$$
and
wherein, CS₁ is defined as a surface compressive stress of the first portion, CS₂ is defined as a surface compressive stress of the second portion, t₁ is defined as a thickness of the first portion, t₂ is defined as a thickness of the second portion, and Ratio is defined as a value obtained by dividing a depth of layer (DOL) of the first portion by t₁.

12. The window as claimed in claim 11, wherein the surface compressive stress of the first portion is substantially the same as the surface compressive stress of the second portion.

13. The window as claimed in claim 11, wherein the Ratio is in a range from 0.15 to 0.25.

14. The window as claimed in claim 11, wherein the surface compressive stress of the first portion and the surface compressive stress of the second portion are each in a range from 500 MPa to 700 MPa.

15. The window as claimed in claim 11, wherein the thickness of the first portion is in a range from 20 μm to 50 μm, and the thickness of the second portion is in a grange from 30 μm to 300 μm.

16. An electronic device comprising:
a display panel; and
a window arranged on the display panel and comprising a glass substrate and a resin layer on one surface of the glass substrate,
wherein the glass substrate comprises:
a first portion on which a groove filled with the resin layer is defined; and
a second portion arranged to extend from the first portion and being thicker than the first portion,
wherein each of the first portion and the second portion comprises:
a first compressive stress area having a first depth from a first surface;
a second compressive stress area having a second depth from a second surface arranged to be opposite to the first surface; and
a tensile stress area between the first compressive stress area and the second compressive stress area, and
wherein a difference (ΔCT) between internal tensile stress at a point of the first portion having a minimum thickness and internal tensile stress at a point of the second portion having a maximum thickness is at most 100 MPa.

17. The electronic device as claimed in claim 16, wherein the resin layer overlaps the first portion and the second portion, and
wherein a thickness of the window corresponding to the first portion is substantially the same as a thickness of the window corresponding to the second portion.

18. The electronic device as claimed in claim 16, wherein the electronic device is foldable with respect to a folding axis, and the folding axis is defined to overlap the groove and extends in substantially the same direction as the groove.

19. The electronic device as claimed in claim 16, wherein the difference (ΔCT) between the internal tensile stress at the point of the first portion having the minimum thickness and the internal tensile stress at the point of the second portion having the maximum thickness satisfies Equation 1:
$$Δ CT = ( \frac{{CS}_{1} \times 1 \times Ratio}{1 - 2 \times 1 \times Ratio} ) - ( \frac{{CS}_{2} \times 1 \times Ratio}{\frac{{t}_{2}}{{t}_{1}} - 2 \times 1 \times Ratio} ) , \qquad Equation 1$$
and
wherein, CS₁ is defined as a surface compressive stress of the first portion, CS₂ is defined as a surface compressive stress of the second portion, t₁ is defined as a thickness of the first portion, t₂ is defined as a thickness of the second portion, and Ratio is defined as a value obtained by dividing a depth of layer (DOL) of the first portion by t₁.

20. The electronic device as claimed in claim 19, wherein the surface compressive stress of the first portion is substantially the same as the surface compressive stress of the second portion, and the Ratio is in a range from 0.15 to 0.25.
